(19) United States
(12) Patent Application Publication
(10) Pub. No.: US 2014/0149308 A1
(43) Pub. Date: May 29, 2014

(54) AUTOMATED PACKAGE TRACKING

(71) Applicant: Erin Christine Ming, Menlo Park, CA (US)

(72) Inventor: Erin Christine Ming, Menlo Park, CA (US)

(73) Assignee: eBay Inc., San Jose, CA (US)

(21) Appl. No.: 13/686,149

(22) Filed: Nov. 27, 2012

(51) Int. Cl. G06Q 10/08

(52) U.S. Cl. CPC G06Q 10/0833
USPC 705/333

(57) ABSTRACT

A system and method are provided herein for tracking packages on a client device. A plurality of messages accessible on the client device may be monitored for information. When certain information, such as shipping and/or status information, is detected within a message of the plurality of messages, such information may be extracted from the message or automatically obtained. A notification may be generated based on the extracted and/or obtained information. The notification may be configured according to user preferences and displayed on the client device.

### TECHNICAL FIELD

The present application relates generally to systems and methods for automatically tracking packages.

### BACKGROUND

Many people receive packages delivered by package carriers, such as, packages for items ordered online or via telephone. It is often difficult to keep track of packages, especially when items have been purchased from multiple merchants within a short period of time, which leads to multiple packages shipped through different package carriers arriving in the same time frame, but not in any particular order. Sometimes items are shipped weeks after being ordered, and the person may have forgotten about having ordered the items. Packages can be tracked manually by checking emails, merchant sites or package carrier sites. However, this process requires the person to remember what orders he or she placed with which merchants, to keep track of the various tracking numbers provided by the merchants, and to make repeated inquiries to different sites.

### BRIEF DESCRIPTION OF THE DRAWINGS

Some embodiments are illustrated by way of example in the accompanying drawings and should not be considered as a limitation of the invention:

FIG. 1 illustrates a network diagram depicting a system for automatically tracking packages, according to an example embodiment.

FIG. 2 is a block diagram showing automated package tracking implemented in modules according to some embodiments.

FIG. 3 illustrates an example flow diagram showing the functionalities or operations of automated package tracking according to some embodiments.

FIGS. 4-8 illustrate examples of user interface (UI) screens provided on a client device associated with an automated package tracker application according to some embodiments.

FIG. 9 is a diagrammatic representation of a machine in the example form of a computer system within which a set of instructions for causing the machine to perform any one or more of the methodologies discussed herein may be executed according to some embodiments.

### DETAILED DESCRIPTION

Described in detail herein is a system and method for a mobile application (also referred to as an “app”) that automatically tracks packages. Each package may include one or more items from an order placed by a user. The app automatically tracks packages without requiring the user to provide login or password for any email accounts. The app requires minimal action and/or input from the user, e.g., downloading the app and permitting the app to access messages on the user's device. The app monitors messages accessible on the user's device and detects information that corresponds to a package to be delivered. Once such a message is detected, the app automatically extracts shipment information and/or status information corresponding to the package from the message, obtains status information corresponding to the package if the status information is not included in the message, and generates a notification on the user's device based on the status information. The shipment information may include a merchant name, a tracking number, a name of the package carrier, an order number, shipment date or the like. If the status information is not included in the message, the app may obtain the status information by checking the package carrier's website, by making application programming interface (API) calls to the package carrier's system, or by accessing the package carrier's app included on the client device. The status information may include a geographic location of the package, a physical location of the package (e.g., on a delivery truck or in a warehouse), a delivery status (e.g., out for delivery, delivered, scheduled for delivery, unable to deliver), a delivery time or the like. The app can then generate a notification based on the status information of the package. If the status information is not available, then the app may generate a notification based on the shipment information.

The following description is presented to enable any person skilled in the art to create and use a computer system configuration and related method and article of manufacture to monitor messages and automatically track packages to provide notification(s) to a user. Various modifications to the example embodiments will be readily apparent to those skilled in the art, and the generic principles defined herein may be applied to other embodiments and application without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

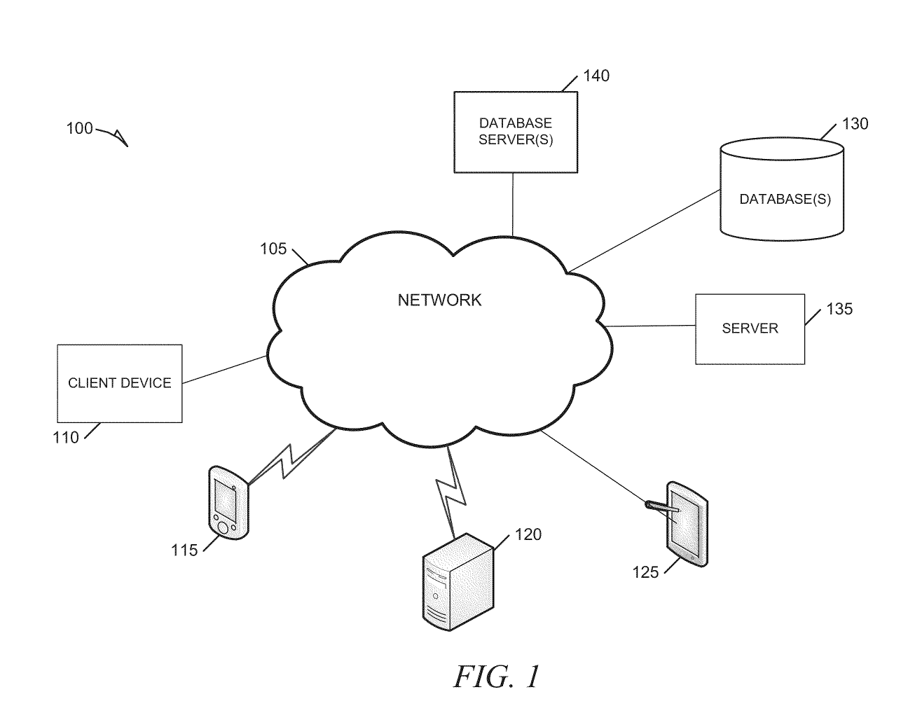

FIG. 1 illustrates a network diagram depicting a system 100 for automatically tracking packages, according to an example embodiment. The system 100 can include a network 105, a client device 110, a client device 115, a client device 120, a client device 125, a database(s) 130, a server 135, and a database server(s) 140. Each of the client devices 110, 115, 120, 125, database(s) 130, server 135, and database server(s) 140 is in communication with the network 105.

In an example embodiment, one or more portions of network 105 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The client devices 110, 115, 120, 125 may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like. Each of client devices 110, 115, 120, 125 may connect to network 105 via a wired or wireless connection. Each of client devices 110, 115, 120, 125 may include one or more applications (also referred to as “apps”) such as, but not limited to, a web browser, messaging application, electronic mail (email) application, package carrier applications, notification application, an automated package tracker application described herein, and the like. In some embodiments, the automated package tracker application included in any of the client devices 110, 115, 120, 125 may be configured to locally provide a user interface, locally perform the functionalities described herein, and communicate with network 105, on an as needed basis, for data not locally available (such as accessing package carrier websites using tracking numbers).

In other embodiments, the automated package tracker application may be included on the client device 110, 115, 120, 125, and the server 135 performs the functionalities described herein. The server 135 may monitor messages accessible on the client device 110, 115, 120, 125, and detect information corresponding to a package in a message. The server 135 may also extract shipment information and/or status information, and if status information is not available, then obtain status information from a package carrier. The server 135 may also generate a notification based on the status information and/or the shipment information.

In another embodiment, the automated package tracker application included in any of the client devices 110, 115, 120, 125 may be configured to locally perform some of the functionalities described herein, while the server 135 performs the other functionalities described herein. For example, the client device 110, 115, 120, 125 may monitor the messages accessible on the client device 110, 115, 120, 125 and detect information corresponding to a package in a message, while the server 135 may extract the information from the message. The server 135 may also extract shipment and/or status information from the message, and if status information is not available then obtain it from a package carrier, via their website, app or the like. The client device 110, 115, 120, 125 may generate a notification based on the status information and/or shipment information, and display the notification on the client device 110, 115, 120, 125 based on a user preference.

In another example, the client device 110, 115, 120, 125 may monitor messages, detect shipment and/or status information corresponding to a package in a message, and extract the information from the message. If status information is not available in the message, then the server 135 may obtain it from a package carrier. The client device 110, 115, 120, 125 may generate a notification based on the status information and/or the shipment information. Although four client devices 110, 115, 120, 125 are shown in FIG. 1, more or less than four client devices can be included in system 100.

Each of the database(s) 130, server 135, and database server(s) 140 is connected to the network 105 via a wired connection. Alternatively, one or more of the database(s) 130, server 135, or database server(s) 140 may be connected to the network 105 via a wireless connection. Although not shown, database server(s) 140 can be (directly) connected to database(s) 130, or server 135 can be (directly) connected to the database server(s) 140 and/or database(s) 130. Server 135 comprises one or more computers or processors configured to communicate with client devices 110, 115, 120, 125 via network 105. Server 135 hosts one or more applications or websites accessed by client devices 110, 115, 120, 125 and/or facilitates access to the content of database(s) 130. Database server(s) 140 comprises one or more computers or processors configured to facilitate access to the content of database(s) 130. Database(s) 130 comprise one or more storage devices for storing data and/or instructions for use by server 135, database server(s) 140, and/or client devices 110, 115, 120, 125. Database(s) 130, server 135, and/or database server(s) 140 may be located at one or more geographically distributed locations from each other or from client devices 110, 115, 120, 125. Alternatively, database(s) 130 may be included within server 135 or database server(s) 140.

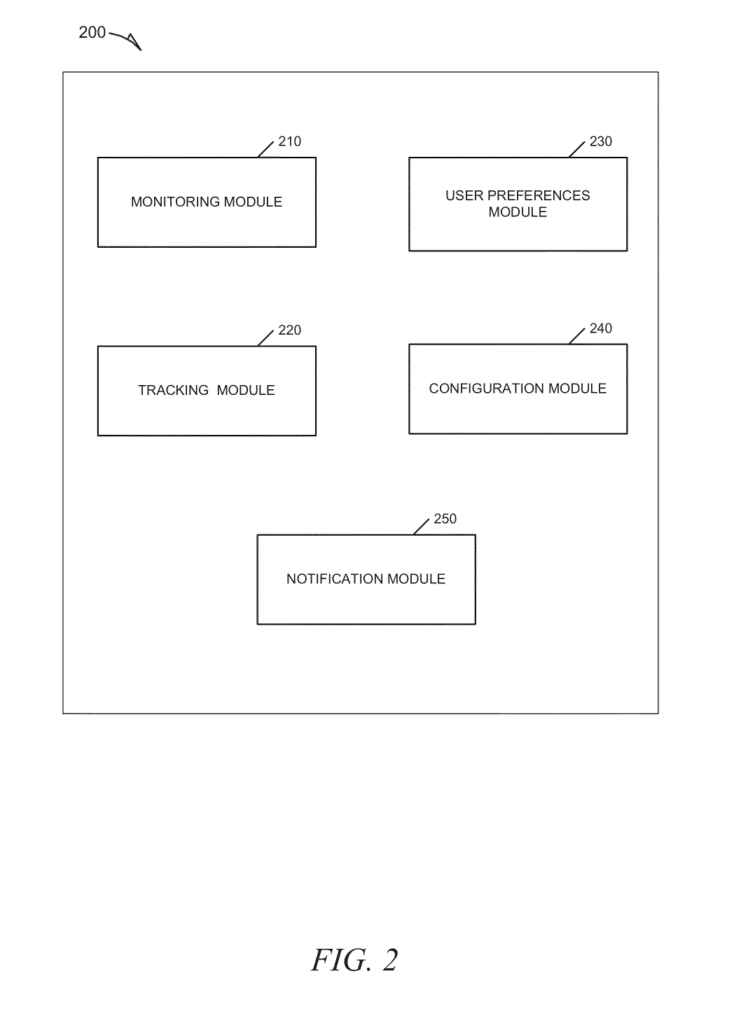

FIG. 2 is a block diagram 200 showing automated package tracking implemented in modules according to an example embodiment. The modules may be implemented in client devices 110, 115, 120, 125. The modules may comprise one or more software components, programs, applications, apps or other units of code base or instructions configured to be executed by one or more processors included in client device 110, 115, 120, and/or 125. In some embodiments, the modules are downloaded from an ecommerce site appropriate for the type of computing device. For example, if the client device 110, 115, 120, or 125 comprises an iOS-type device (e.g., iPhone or iPad), then the modules can be downloaded from iTunes. Similarly, if the client device 110, 115, 120 or 125 comprises an Android-type device, then the modules can be downloaded from the Android Marketplace or Google Play Store. The modules may be packaged as an automated package tracker app. In other embodiments, one or more of modules 210-250 may be included in server 135 or database server(s) 140 while other of the modules 210-250 are provided in the client devices 110, 115, 120, 125. Although modules 210-250 are shown as distinct modules in FIG. 2, it should be understood that modules 210-250 may be implemented as fewer or more modules than illustrated. It should be understood that any of modules 210-250 may communicate with one or more components included in system 100, such as database(s) 130, server 135, database server(s) 140, or client devices 110, 115, 120, 125. The modules include a monitoring module 210, a tracking module 220, a user preferences module 230, a configuration module 240, and a notification module 250.

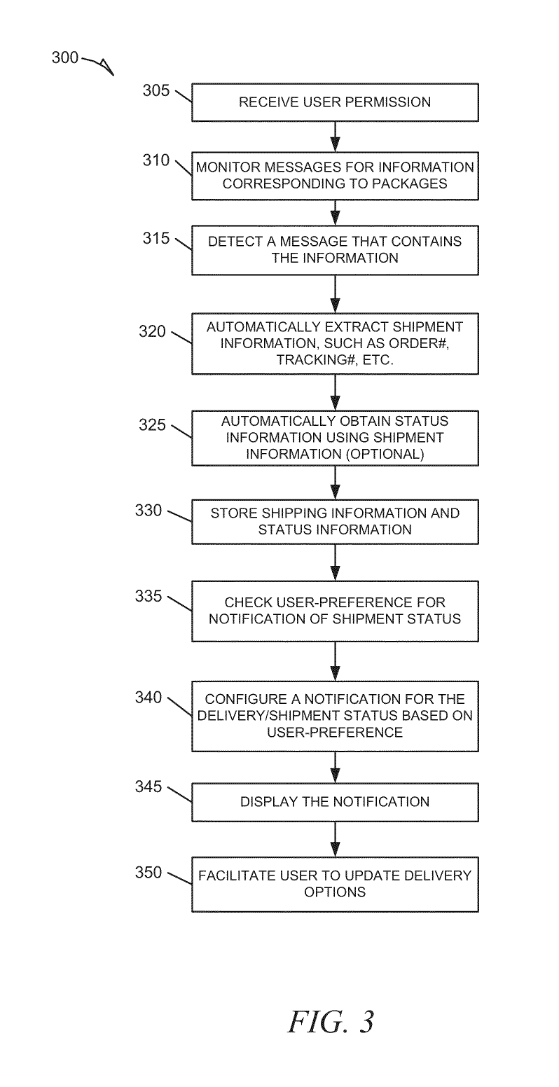

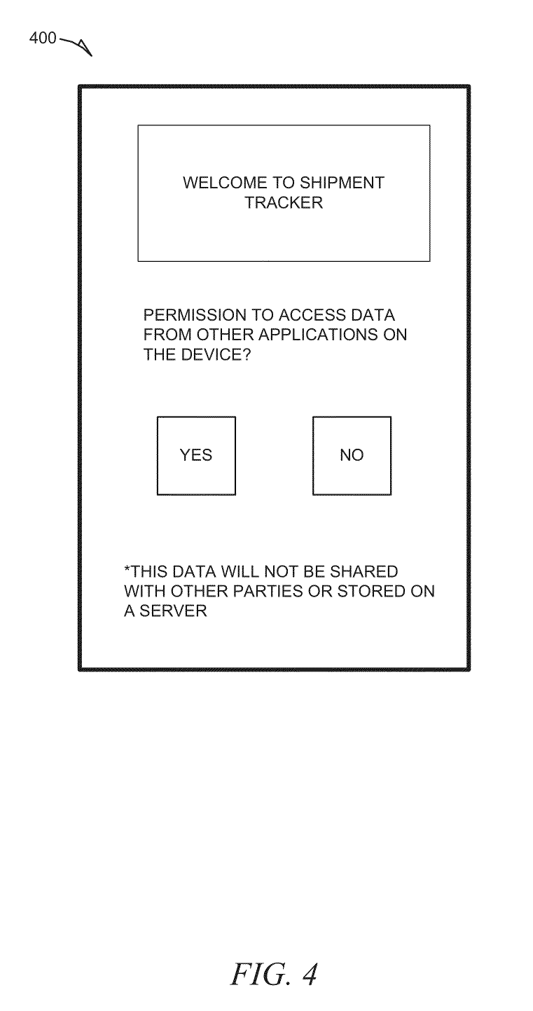

FIG. 3 illustrates an example flow diagram 300 showing the operations of automated package tracking according to an embodiment. FIGS. 4-8 illustrate examples of user interface (UI) screens provided on a client device 110, 115, 120, or 125 associated with an automated package tracker application according to some embodiments. FIGS. 2-8 are described below in conjunction with each other to describe one or more embodiments of automated package tracking. The automated package tracking mechanism disclosed herein facilitates automatically tracking a package by monitoring messages accessible on a client device. The automated package tracking mechanism may also be referred to herein as an automated package tracker, a shipment tracker, a delivery status mechanism, shipment status mechanism, package tracker mechanism, shipment update mechanism, and similar terms.

A user can access the automated package tracking mechanism on client device 110, 115, 120, 125. In some embodiments, the application(s) corresponding to the automated package tracking mechanism may be directly launched on the client device 110, 115, 120, 125 as an app.

If this is the first time a user is accessing the automated package tracking mechanism, then at a block 305 of FIG. 3, a monitoring module 210 of FIG. 2 can request and receive user permission to monitor and access messages accessible on the client device 110, 115, 120, 125, as shown in FIG. 4. The monitoring module 210 may be configured to display a user permission screen as shown in FIG. 4 at the client device 110, 115, 120, 125. FIG. 4 is a user interface screen 400 illustrating a welcome screen and requesting user permission to access data from other applications on the same client device 110, 115, 120, 125. The user can click, select, touch or otherwise indicate either “YES” or “NO.” If the user selects “YES” then the automated package tracking mechanism may proceed to the next steps. If the user selects “NO” then the automated package tracking mechanism may exit or ask the user for permission again. In some embodiments, a user preferences module 230 may be configured to receive and store user permission to access data on the client device. In some embodiments, the automated package tracking mechanism may or may not require the user to set up a username and password as login information to start using the application.

At a block 310, a monitoring module 210 can be configured to monitor messages for information that correspond to a package to be delivered. The monitoring module 210 monitors messages accessible on the client device 110, 115, 120, 125 including email messages, short message service (SMS), multimedia message service (MMS), text messages, notification messages, or any other type of messages that may be received by, displayed on, generated on, or accessible on a client device 110, 115, 120, or 125. These messages may be received as part of applications included in the client device 110, 115, 120, or 125. The client device 110, 115, 120, 125 may include email applications and SMS/MMS applications such as Microsoft Outlook client, Thunderbird email client, Google email clients, Yahoo email application, iPhone SMS text application, Android text message application, third party messaging applications such as WhatsApp, LINE, kiki, and the like. The messages may also be generated by applications on the client device 110, 115, 120 or 125, such as by merchant-specific applications or package carrier applications. Additionally, the client device 110, 115, 120, 125 may include notification applications such as notification center on iPhone, Android notifications, and the like.

At a block 315, the monitoring module 210 detects a message that contains information corresponding to a package to be delivered. Information may include keywords (e.g., order, confirmation, shipment, invoice, tracking number, purchase, payment, delivery, or other words that indicate a package has shipped or will be shipped), hyperlinks, sounds, and pictures. In some embodiments, the monitoring module 210 may only monitor incoming messages, and stored messages are not analyzed. As such, the automated package tracking mechanism is “forward” looking, and does not access old messages. In other embodiments, the monitoring module 210 may analyze old messages stored on the client device. In still other embodiments, the monitoring module 210 may monitor both incoming messages and stored messages for information corresponding to shipment of a package. In an example embodiment, the monitoring module 210 may monitor messages for multiple keywords or a single keyword.

The monitoring module 210 can monitor a plurality of messages on the client device 110, 115, 120, 125 and detect that one of the plurality of messages includes information corresponding to a package to be delivered. One or more items may be included in the package to be delivered. The monitoring module 210 may monitor the plurality of messages in real-time. In other embodiments, the monitoring module 210 may monitor previously received messages. Real-time means that messages are being monitored and detected for information corresponding to packages as soon as they are accessible by the client device. The messages may be stored on the client device 110, 115, 120, 125 or they may be hosted on a cloud environment, in that case, the client device 110, 115, 120, 125 may access the messages on the cloud environment.

In some embodiments, the monitoring module 210 may isolate a message that contains information corresponding to a package to be delivered. For example, the monitoring module 210 may detect a keyword within a particular message from the plurality of messages, and isolate the particular message from the plurality of messages, and only parse that particular message. This reduces the amount of messages and data the automated package tracking mechanism has to analyze and parse in order to obtain shipment and status information. It is understood that isolation of the particular message may be conceptual and such message need not literally be segregated in a separate application or data structure.

Next at a block 320, a tracking module 220 is configured to extract information from the message. For example, the tracking module 220 may parse the isolated message or the monitored messages. The tracking module 220 may parse a single message or multiple messages at the same time. In some embodiments, the tracking module 220 can automatically extract shipment information and/or status information related to the package from the message. Shipment information may include, but is not limited to, a merchant name, a tracking number, a name of the package carrier, an order number, a shipment date, an estimated shipment date, or other static-type of information about the package. Status information may include, but is not limited to, a geographic location of the package, a physical location of the package (e.g., on a delivery truck or in a warehouse), a delivery status (e.g., out for delivery, delivered, scheduled for delivery, unable to deliver), a delivery date, a delivery time, an estimated delivery date, an estimated delivery time, or other dynamic-type of information about the package. The shipment information generally relates to the “what” about the package, such as fixed package or order identifier information, while the status information generally relates to the “where” and/or “when” about the package. As another example, the shipment information generally relates to information provided by a merchant or information within the merchant's control, while the status information generally relates to information provided by a package carrier or information within the package carrier's control. For example, shipment information may be in the merchant's control because the merchant determines when and how a package is shipped. While the status information may be in the package carrier's control because the package carrier determines when and where the package is delivered after it has been shipped.

In one embodiment, the message may include shipment information and status information related to the package, and the tracking module 220 extracts both shipment information and status information. In this case, the tracking module 220 need not obtain status information at block 325 using the shipment information. In another embodiment, the message may include only shipment information, and the tracking module 220 may automatically obtain status information related to the package using the extracted shipment information if the status information is not included in the message.

In an example embodiment, the tracking module 220 may have extracted a tracking number as part of the extracted shipment information related to the package. In this case, the tracking module 220 may make Application Programming Interface (API) calls to package carrier systems, and obtain status information using the tracking number extracted from the message as part of the shipment information. Package or shipment carriers include, but are not limited to, United States Postal Service (USPS), United Parcel Service (UPS), Federal Express (FedEx), Dalsey, Hillblom, and Lynn (DHL), and other local, regional, domestic and international carriers.

In another example, the tracking module 220 may launch the package carrier's application included on the client device 110, 115, 120, 125 to obtain the status information using the tracking number. Alternatively, the tracking module 220 may access the package carrier's website via a web browser included in the client device 110, 115, 120, 125 to obtain the status information. In a further example, if a tracking number is not extracted as part of the shipment information at block 320 because one was not included in the message, then the tracking module 220 may use other extracted shipment information to obtain the status information. For example, the tracking module 220 may access a merchant's website or launch a merchant's application included on the client device 110, 115, 120, 125. The tracking module 220, for example, may use the order number extracted from the message and obtain a tracking number corresponding to the package from the merchant's website or application.

Alternatively, the tracking module 220 may not be able to obtain status information using the extracted shipment information. In this case, the tracking module 220 may not obtain status information until a tracking number is extracted at block 320. Alternatively, the tracking module 220 may obtain status information when shipment information capable of obtaining status information is extracted. In some embodiments, the tracking module 220 may not contact the package carrier website or application if a tracking number is not available. If a tracking number is not available and/or status information is not obtained by the tracking module 220, the configuration module 240 and the notification module 250 (discussed later) can configure and display a notification based on the shipment information that is extracted from the message. For instance, a message may notify the user that a package has shipped on a certain date, but not provide a tracking number. The configuration and notification modules 240, 250 provide the shipment date (extracted from the message) to the user but does not check for status information with the package carrier because no tracking number is available.

In some embodiments, the tracking module 220 may periodically update the status information using the extracted shipment information. For example, the tracking module 220 may make API calls to the package carrier websites, launch the package carrier's app on the client device 110, 115, 120, 125, and/or access the package carrier website via the web browser included the client device 110, 115, 120, 125. The tracking module 220 may update the status information once a day or at some other pre-defined frequency. In other embodiments, the tracking module 220 may update status information based on a user preference. The user may be able to configure how often the tracking module 220 updates status information. In an example embodiment, the tracking module 220 can update the status information based on incoming messages on the client device or update the status information from a website of a package carrier.

Next, the tracking module 220, at a block 330, may store the shipment information and/or the status information. For example, the tracking module 220 may store shipment information and/or status information on the client device 110, 115, 120, 125 according to a user preference. The tracking module 220 may store shipment and/or status information corresponding to packages to be delivered. In some embodiments, the tracking module 220 may also store shipment and/or status information corresponding to packages already delivered for a given number of days. The user may be able to configure the length of time that the shipment and/or status information is retained.

A user preferences module 230, at a block 335, can receive and check user preferences for notification of package status. For example, the automated package tracker application may allow the user to set preferences regarding various functionalities of the application. The user preferences module 230 may store the preferences on the client device 110, 115, 120, 125. When appropriate, the user preferences module 230 may check the various preferences. For example, the user preferences module 230 may check the user's preference for display of a notification corresponding to a package before displaying the notification. The notification can indicate that a package has been delivered, a package has shipped, shipment information has been received, or status information has been updated.

The notification may be configurable by the user in some embodiments. The user may configure how the notification is displayed or delivered on the client device 110, 115, 120, 125. In some embodiments, the user may be able to configure notifications to be displayed as a push notification, a bar notification, a pop-up notification, a calendar-view notification, or a detailed notification. The user preferences module 230 may also allow the user to configure the frequency of notifications. In an example embodiment, the user may be able to configure the application so that it displays a notification a week after the order is confirmed. In other embodiments, user preferences module 230 permits the user to select from a plurality of different amount of details to be provided in the notification.

A configuration module 240, at a block 340, configures or customizes a notification for status of a package based on the user preference. For example, depending on the user preferences, the configuration module 240 may configure the shipment and/or status information to be appropriately displayed as a push notification, a bar notification, a pop-up notification, a calendar-view notification, a detailed notification, or in any other user specified format. In some embodiments, the configuration module 240 may configure the displayed notification to include the delivery date and/or delivery time. In other embodiments, the configuration module 240 may configure the displayed notification to include a merchant name, an order number, a package carrier, a tracking number, a shipment date, an estimated shipment date, a delivery date, and/or an estimated delivery date. The displayed notification may also include the message application that the information was obtained from, and/or a date that the information was obtained or updated.

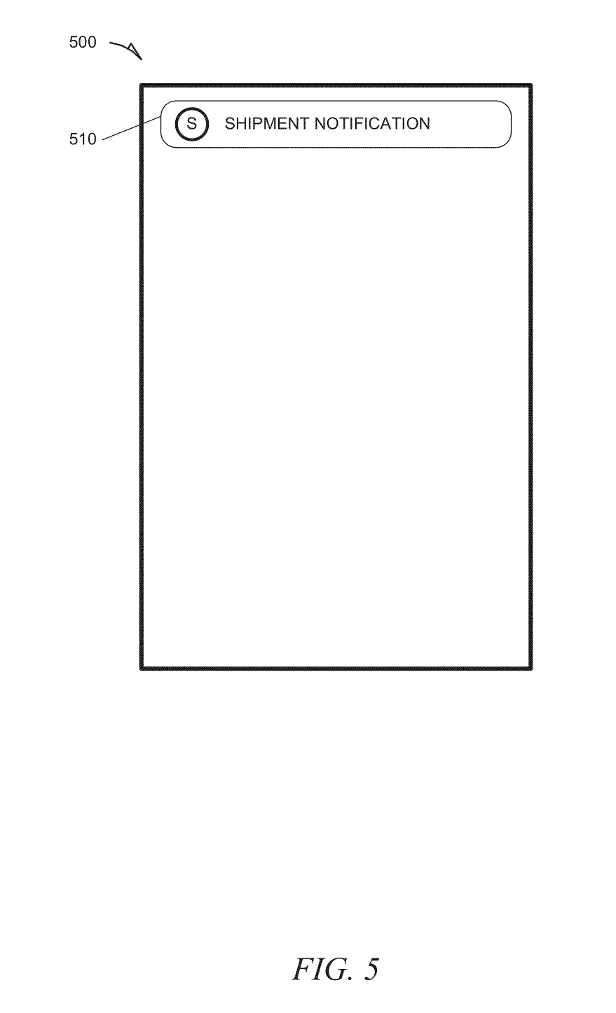

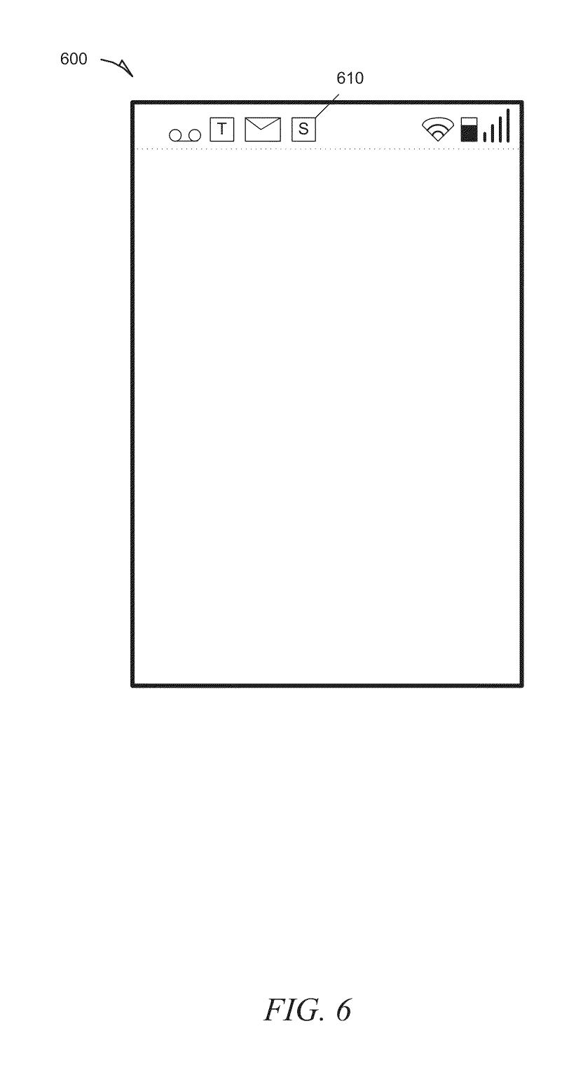

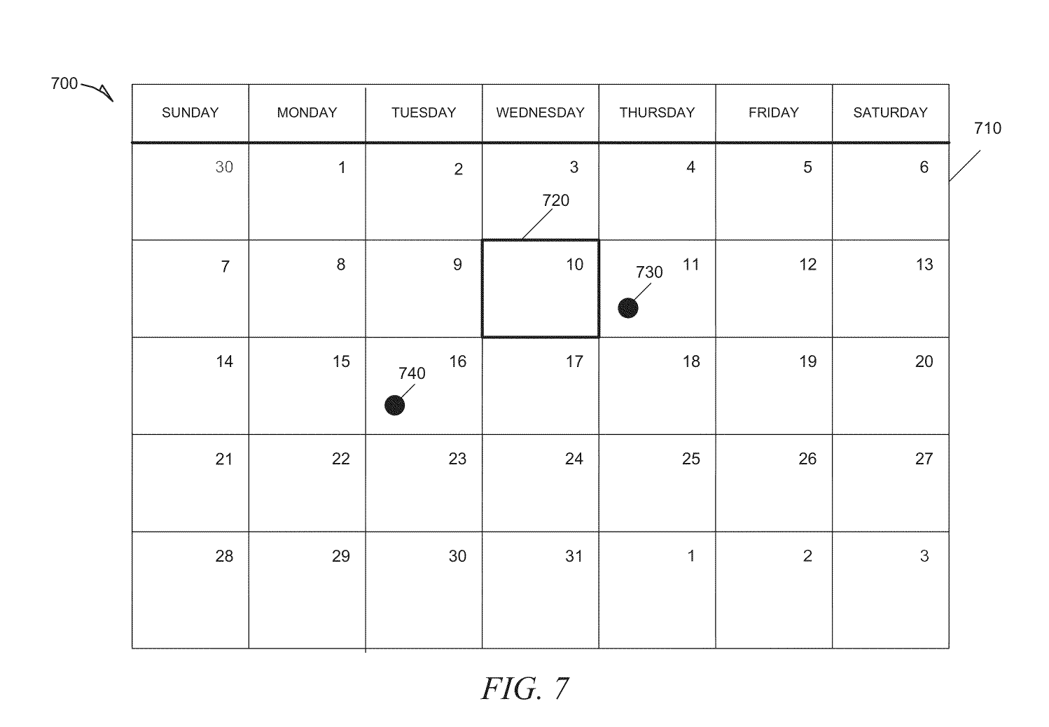

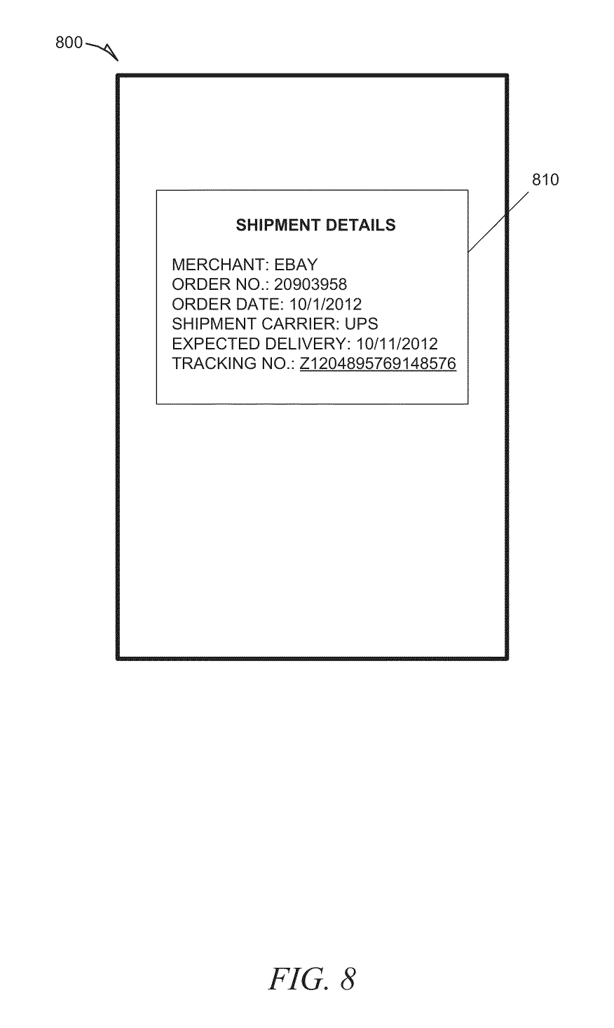

After the notification is configured, a notification module 250, at a block 345, displays the notification on the client device 110, 115, 120, or 125. Depending on the user preferences, the notification module 250 may display a notification when a package has been delivered, when a package is shipped, when shipment and/or status information is updated, and/or when shipment and/or status information becomes available. In some embodiments, the notification module 250 may play a sound along with a displayed notification, or only play a sound without displaying a notification. The client device 110, 115, 120, 125 may also vibrate, display a blinking or solid light, or produce any other similar notification in addition to or in lieu of a displayed notification. The notification module 250 may display the notification as a push notification as shown in FIG. 5, a bar notification as shown in FIG. 6, a pop-up notification, a calendar-view notification as shown in FIG. 7, a detailed notification as shown in FIG. 8, or any other user customized display technique.

FIG. 5 shows a user interface screen 500 displaying the notification as a push notification 510. The push notification 510 is shown at the top of the user interface screen 500, however, it is understood that the push notification 510 may be displayed anywhere on the user interface screen 500. The push notification 510 may include an icon and text associated with the icon. Different icons may indicate different shipment and/or status information. For example, one icon may indicate that a package has been delivered, while another icon may indicate that a package has been shipped. The icons may be configured by the user of the client device 110, 115, 120, 125. Corresponding text may be displayed with different icons in the push notification 510. The user may be able to click or select or touch the push notification 510 to view more information. Upon clicking, selecting, or touching the push notification 510, the client device 110, 115, 120, 125 may display a calendar-view notification shown in FIG. 7 or display a detailed notification as shown in FIG. 8. Additionally, the user may be able to use a voice command to display a calendar-view notification shown in FIG. 7 or a detailed notification shown in FIG. 8.

FIG. 6 shows a user interface screen 600 displaying the notification as a bar notification 610. The bar notification 610 is shown at the top of the user interface screen 600, however, it is understood that the bar notification 610 may be displayed anywhere on the user interface screen 610. In some embodiments, the bar notification 610 may display an icon indicating a notification. Different icons may indicate different shipment and/or status information. For example, one icon may indicate that a package is out-for-delivery or has been delivered, while another icon may indicate that a package has been shipped. Another icon may indicate that an attempt to deliver a package was made. The icons may be configured by the user of the client device 110, 115, 120, 125. Various other icons may be displayed along the bar notification 610 that indicate other device information, such as voicemail, text message, email, wireless signal, battery status, cell phone signal, and other similar information. The user may be able to click or select or touch the bar notification 610 to view more information. Upon clicking, selecting, or touching the bar notification 610, the client device 110, 115, 120, 125 may display a calendar-view notification shown in FIG. 7 or display a detailed notification as shown in FIG. 8. Additionally, the user may be able to use a voice command to display a calendar-view notification shown in FIG. 7 or a detailed notification shown in FIG. 8.

FIG. 7 shows a user interface screen 700 comprising a calendar-view notification 710. The calendar-view notification 710 may include an indication of today's date 720, a notification icon 730, and a notification icon 740. Today's date 720 may be indicated by displaying a thick border around the date or a different color border or any other similar technique. Notification icons 730, 740 may indicate a package delivery date, a package shipment date, an estimated package delivery date, or an estimated package shipment date. Notification icons 730, 740 may be displayed in different colors and/or shapes depending on user preferences, and/or depending on the shipment and/or information that it indicates. If there is more than one event occurring on a particular date (e.g. multiple packages are being delivered on the particular date), then the calendar-view notification 710 may comprise more than one notification icon for that particular date. The calendar-view notification 710 may also indicate a delivery time near the notification icons 730, 740 is a delivery time is available. The user may be able to click or select or touch the notification icon 730, 740 to view more information. Upon clicking, selecting, or touching the notification icons 730, 740, the client device 110, 115, 120, 125 may display a detailed notification as shown in FIG. 8. Additionally, the user may be able to use a voice command to display a detailed notification shown in FIG. 8.

FIG. 8 shows a user interface screen 800 comprising a detailed notification 810. The detailed notification 810 may include a merchant name, a tracking number, a name of a package carrier, an order number, a shipment date, an estimated shipment date, a geographic location of the package, a physical location of the package (e.g., on a delivery truck or in a warehouse), a delivery status (e.g., out for delivery, delivered, scheduled for delivery, unable to deliver), a delivery date, a delivery time, an estimated delivery date, an estimated delivery time, or the like. The user may be able to click, select or touch the tracking number in the detailed notification, which may direct the user to the package carrier website or the package carrier app. Additionally, the user may be able to use a voice command to access the package carrier website or the package carrier app. The detailed notification 810 is shown in the center of the user interface screen 800, however, it is understood that the detailed notification 810 may be displayed anywhere on the user interface screen 800.

After the notification is displayed, the notification module 250, at a block 350, is configured to facilitate the user to update or change delivery options. The user may be able to pre-sign for the package delivery or provide instructions on where to leave the package when it is delivered. The user may also be able to provide an alternative address for delivery, set up a re-delivery time or schedule a pickup of the package at the package carrier. The notification module 250 may launch the package carrier's website or application to allow the user to update delivery options. Alternatively, the notification module 250 may allow the user to update delivery options through the automated package tracker application without launching a separate application. The notification module 250 may store this information and communicate the information to the package carrier. The notification module 250 may also store the information so that the user can easily re-use the information to update delivery options for other package(s).

As an example, the automated package tracker application may be installed on a user's mobile phone. The mobile phone may be set up to access email messages, text messages, and notifications on the mobile phone. The automated package tracker application can monitor these messages on the mobile phone. The user may receive an email message about a package which is going to be shipped. This email message may contain keywords such as order confirmation or shipment confirmation. The automated package tracker application may detect one or more of these keywords, and may isolate the email message. Then this email is parsed to identify shipment information and/or status information, such as an actual or estimated shipping date, an actual or estimated delivery date, a merchant name, an order number, a name of a package carrier, a tracking number, etc. After parsing, the identified information is extracted from the email and stored on the mobile phone.

If the email does not include status information corresponding to shipment of the package and a tracking number is identified and extracted, then the tracking number can be used to obtain the status information. For example, if the package carrier is identified as UPS, then the automated package tracker application may launch a web browser on the user's mobile phone, and obtain status information from the UPS tracking website using the extracted tracking number. Alternatively, the automated package tracker application may launch the UPS app installed on the user's mobile device to obtain the status information. This status information obtained from the package carrier may be used in addition to the shipment information extracted from the email in generating the notification on the mobile device. The status information obtained from the package carrier may also be used to update other information extracted from the email, such as delivery and/or shipment date.

If a tracking number is not available in the email, then the automated package tracker application may continue to monitor incoming emails for a tracking number corresponding to the order number or item number in the email. When a tracking number is available, then the automated package tracker application can obtain the status information from UPS. Alternatively, the automated package tracker application can attempt to obtain the tracking number from a merchant's website or through a merchant's app on the mobile device using the order number extracted from the email.

Once the shipment information is extracted from the email, and the status information is obtained from UPS (if accessible or available), the automated package tracker application configures the information according to the user's preferences. For example, the user may have chosen to be notified on the mobile phone via a bar notification, and to display a calendar-view notification when the user clicks on the bar notification. In this case, the automated package tracker application can display an actual or estimated delivery date (if not available, then an actual or estimated shipment date is displayed) as a bar notification. When the user selects the bar notification, the calendar-view notification is displayed with an icon, such as a dot, representing the delivery date. If the package is out-for-delivery, then a delivery time may be displayed next to the dot on the calendar-view.

It is contemplated that one or more blocks of FIG. 3 may be implemented differently (e.g., in different order, in combination, or the like) than shown within the scope of embodiments of the present disclosure. For example, block 335 can be performed simultaneously with block 330, or block 335 can be performed anytime before block 340. As another example, block 325 can be performed simultaneously with block 320.

In this manner, a mechanism is provided for tracking packages. A plurality of messages accessible on a client device are monitored for information, such as keywords, hyperlinks or the like, corresponding to a package to be delivered. The information may indicate that a package is to be delivered containing one or more items that may have been purchased. When at least one keyword is detected within a message of the plurality of messages, shipment and/or status information from the message is extracted. If no status information is found in the message, then status information is automatically obtained. The shipment information includes at least one of a merchant name, a tracking number, a name of a package carrier, an order number, an estimated shipment date and a shipment date. The status information includes at least one of a delivery date, an estimated delivery date, a delivery time, an estimated delivery time, a delivery status, a geographic location, and a physical location.

A notification is generated based on the shipment and/or status information and displayed on the client device in accordance with user preferences. The plurality of messages may be monitored for a package being shipped by a merchant, and for another package being shipped by a different merchant. Two different messages corresponding to the two packages may be accessible on the client device. Shipment and status information corresponding to both packages may be extracted from the two messages, or status information corresponding to the two packages may be automatically obtained using the extracted shipment information. A notification may be generated based on the shipment and/or status information corresponding to the two packages that were shipped by the different merchants. The notification may be displayed as a bar notification, a push notification, a calendar-view notification, or a detailed notification. The notification may be displayed in accordance with a preference of a user of the client device. The status information may be obtained from a package carrier.

The plurality of messages may be monitored in real-time (as messages are accessible by the client device). The shipment and/or status information may be stored on the client device. The shipment and/or status information may be updated based on incoming messages, or by checking the tracking number on a package carrier website or application. The automated package tracker application may request and receive user permission to access messages and data on the client device. The plurality of messages may comprise email messages, SMS messages MMS messages, or a notification message from other applications included on the client device.

The mechanism can help users keep track of their packages, with minimal input from the user. It does not require users to provide login and password information in order to monitor and access the messages accessible on the client device. Additionally, it need not store or analyze private user data that is irrelevant to package tracking. The automated package tracker application can focus on messages that contain package information, and does not fully analyze or read other irrelevant messages. This limited data analysis helps protect the user's privacy because the application does not fully analyze and read other personal messages. The application can be configured to avoid storing information or messages on a server or a database for purposes of gathering user data. Once the message is detected, only the extracted shipment and/or status information may be stored, while the remainder of the message is ignored.

The application may help in reminding the user of item orders or pre-orders that he or she placed some time ago and has not shipped. The application may also notify the user of a scheduled delivery the day of the delivery, so the user can be available to receive the package. The application may notify the user of future scheduled or estimated delivery dates, so that the user may be available at that time or arrange for someone else to receive the package. The user need not manually check one or more times for status information for a given order, or manually keep track of shipping status of multiple items. Instead, the automated package tracker mechanism described herein provides automated and consolidated up-to-date shipping and/or delivery information about all the user's packages.

Although embodiments are described herein for an automated package tracker application, the mechanisms and techniques described in the embodiments may be implemented to automatically track other items of interest, such as bills, payments, travel, tasks, etc. The embodiments may be implemented to track progression of items that have a start date, an end date, and/or a due date. Generally, the disclosure described herein may be implemented to track items that have milestones associated with them.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

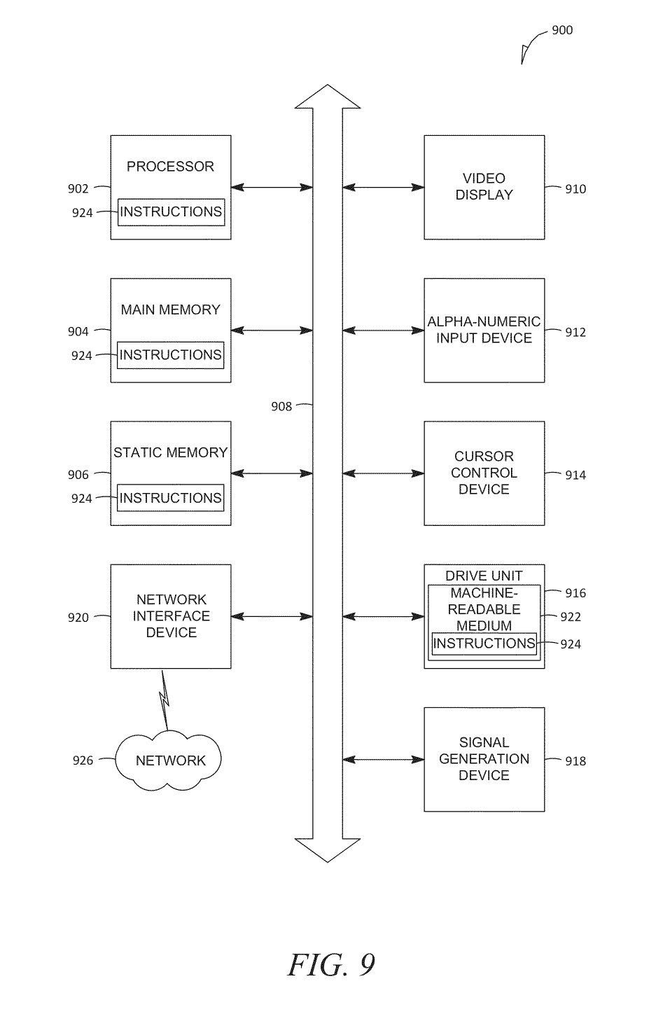

FIG. 9 is a block diagram of machine in the example form of a computer system 900 within which instructions, for causing the machine (e.g., client device 110, 115, 120, 125; server 135; database server(s) 140; database(s) 130) to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD), a touch screen, or a cathode ray tube (CRT)). The computer system 900 also includes an alphanumeric input device 912 (e.g., a physical or virtual keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software) 924 embodying or used by any one or more of the methodologies or functions described herein. The instructions 924 may also reside, completely or at least partially, within the main memory 904, static memory 906, and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third” and so forth are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for tracking packages, the method comprising:
monitoring a plurality of messages accessible on a client device;
detecting information corresponding to a package within a message of the plurality of messages;
automatically extracting the information corresponding to the package from the message; and
generating a notification based on the extracted information.

2. The method of claim 1, wherein automatically extracting the information corresponding to the package comprises:
automatically extracting shipment information corresponding to the package from the message.

3. The method of claim 2, wherein the shipment information includes at least one of a merchant name, a tracking number, a name of a package carrier, an order number, an estimated shipment date, and a shipment date.

4. The method of claim 2, further comprising:
determining whether status information corresponding to the package is included in the message;
automatically extracting the status information corresponding to the package when the status information is included in the message; and
automatically obtaining the status information corresponding to the package using the extracted shipment information when the status information is not included in the message.

5. The method of claim 4, wherein the status information includes at least one of a delivery time, an estimated delivery time, a delivery status, a geographic location, and a physical location.

6. The method of claim 1, further comprising:
detecting information corresponding to a second package within a second message of the plurality of messages, the package associated with a first merchant and the second package associated with a second merchant; and
automatically extracting the information corresponding to the second package from the second message,
wherein generating the notification comprises generating the notification based on the extracted information corresponding to the package and the second package.

7. The method of claim 6, wherein the first merchant is different from the second merchant.

8. A non-transitory machine-readable medium comprising a set of instructions that, when executed by a processor, causes the processor to perform operations to facilitate tracking packages, the set of instructions comprising:
monitoring a plurality of messages accessible on a client device;
detecting information corresponding to a package within a message of the plurality of messages;
automatically extracting the information corresponding to the package from the message; and
generating a notification based on the extracted information.

9. The non-transitory machine-readable medium of claim 8 wherein automatically extracting the information corresponding to the package comprises automatically extracting shipment information corresponding to the package from the message and the set of instructions further comprises:
determining whether status information corresponding to the package is included in the message;
automatically extracting the status information corresponding to the package when the status information is included in the message; and
automatically obtaining the status information corresponding to the package using the extracted shipment information when the status information is not included in the message.

10. The non-transitory machine-readable medium of claim 9, wherein generating the notification comprises generating the notification based on at least one of the shipment information and the status information.

11. The non-transitory machine-readable medium of claim 9, wherein automatically obtaining the status information comprises automatically obtaining the status information from a package carrier.

12. The non-transitory machine-readable medium of claim 8, wherein the set of instructions further comprises:
displaying the notification on the client device based on a preference of a user of the client device.

13. The non-transitory machine-readable medium of claim 8, wherein monitoring the plurality of messages comprises monitoring the plurality of messages as each message of the plurality messages is accessible at the client device.

14. The non-transitory machine-readable medium of claim 8, wherein the set of instructions further comprises:
receiving permission from the user to monitor the plurality of messages accessible on the client device.

15. The non-transitory machine-readable medium of claim 8, wherein the plurality of messages includes at least one of an email message, a short message service (SMS) message, a multimedia message service (MMS) message, and a notification message.

16. The non-transitory machine-readable medium of claim 15, wherein the notification message is a message on the client device from an application included on the client device.

17. A system comprising a processor-implemented client executing on a processor included in a client device to facilitate tracking packages on the client device, the processor-implemented client being configured to:
monitor a plurality of messages accessible on a client device;
detect information corresponding to a package within a message of the plurality of messages;
automatically extract the information corresponding to the package from the message; and
generate a notification based on the extracted information.

18. The system of claim 17, wherein the processor-implemented client is further configured to configure the notification based on a preference of a user of the client device.

19. The system of claim 17, wherein a display in communication with the processor is configured to display the notification based on a preference of a user of the client device.

20. The system of claim 19, wherein the notification is displayed as at least one of a bar notification, a push notification, a calendar-view notification, and a detailed shipment or delivery information notification.
